(19) United States
(12) Patent Application Publication
(10) Pub. No.: US 2014/0166130 A1
(43) Pub. Date: Jun. 19, 2014

(54) ANTI-SURGE VALVE

(71) Applicants: Hyundai Motor Company, Seoul (KR); Kia Motors Corporation, Seoul (KR)

(72) Inventors: Young Soo Jin, Yongin-si (KR); Kyung Woo Lee, Seoul (KR); Kyu Seok You, Pyeongtaek-si (KR); Woojin Lee, Seoul (KR); Sukyong Song, Daejeon (KR)

(73) Assignees: Kia Motors Corporation, Seoul (KR); Hyundai Motor Company, Seoul (KR)

(21) Appl. No.: 13/955,916

(22) Filed: Jul. 31, 2013

(30) Foreign Application Priority Data
Dec. 17, 2012 (KR) 10-2012-0147777

(51) Int. Cl. F16K 31/126

(52) U.S. Cl. CPC F16K 31/126
USPC 137/488

(57) ABSTRACT

An anti-surge valve opens or closes a path depending on a negative pressure formed at an intake manifold, and includes an operating unit movable in a direction in response to the negative pressure, a spring means provided to push the operating unit in a direction opposite to the moving direction of the operating unit in response to the negative pressure, a spring mounting portion for mounting the spring means, and a diaphragm disposed to cover an outer surface of the operating unit. The diaphragm may be formed in a substantially hollow cylindrical shape and include a circumference portion formed along a circumference of an opened top surface of the diaphragm, a coupling portion formed along a circumferential direction from an outer end of the circumference portion, and a side portion extended substantially vertically from an inner end of the circumference portion, and has substantially uniform outer and inner diameters.

### CROSS-REFERENCE TO RELATED APPLICATION

The present application claims priority of Korean Patent Application Number 10-2012-0147777 filed Dec. 17, 2012, the entire contents of which application are incorporated herein for all purposes by this reference.

### BACKGROUND OF INVENTION

1. Field of Invention

The present invention relates to an anti-surge valve, and more particularly, to an anti-surge valve having an improved durability.

2. Description of Related Art

In general, a flow of an intake air in a CNG (Compressed Natural Gas) engine is controlled by an electronic throttle valve. During a tip-out condition in such a CNG engine, the throttle valve is closed. When the throttle valve is closed, a back flow of the intake air may occur.

In particular, when a turbocharger is mounted, noise and vibration may occur while a blade of a compressor collides with the back flow of the intake air. Furthermore, the durability of the turbocharger may be deteriorated.

In order to solve such a problem, a bypass line is formed between a front air path and a rear air path of the compressor, and an anti-surge valve is interposed on the bypass line to selectively open and close the bypass line. Furthermore, a valve operating unit of the anti-surge valve is connected to an intake manifold. Furthermore, as the throttle valve is closed during a tip-out condition, negative pressure is generated at the intake manifold, and the valve operating unit of the anti-surge valve is operated by the generated negative pressure to open the bypass line.

Therefore, high-pressure air of the rear air path of the compressor is recirculated to the front air path, and noise and vibration occurring in a wheel of the compressor during a tip-out condition may be reduced.

However, when a diaphragm formed of rubber or plastic resin having lower durability than the materials of other constituent elements forming the anti-surge valve is corroded or torn, the role of the anti-surge valve may not be smoothly performed. Therefore, the function of the engine may be deteriorated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an anti-surge valve including a diaphragm having an improved durability.

Various aspects of the present invention provide an anti-surge valve that opens or closes a path depending on a negative pressure formed at an intake manifold. The anti-surge valve may include an operating unit movable in a direction in response to the negative pressure formed at an intake manifold, a spring means provided to push the operating unit in a direction opposite to the moving direction of the operating unit in response to the negative pressure formed at an intake manifold, a spring mounting portion for mounting the spring means, and a diaphragm disposed to cover an outer surface of the operating unit. The diaphragm may be formed in a substantially hollow cylindrical shape and include a circumference portion formed along a circumference of an opened top surface of the diaphragm, a coupling portion formed along a circumferential direction from an outer end of the circumference portion, and a side portion extended substantially vertically from an inner end of the circumference portion, and has substantially uniform outer and inner diameters.

The diaphragm may further include a stepped portion formed to be stepped from the side portion and having a smaller diameter than the side portion, wherein a bottom surface of the diagram may be connected to the stepped portion, one end of the side portion may be bent toward the center of the cylinder, and the stepped portion may be extended substantially vertically from the bent end of the side portion to the bottom surface of the diaphragm.

The circumference portion may have a cross-section formed in a substantially upside-down U-shape. The coupling portion may be formed at a lower level than the circumference portion. The diaphragm may be formed of a material comprising FKM60.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an exemplary anti-surge valve in a closed state according to the present invention.

FIG. 2 is a diagram illustrating an exemplary anti-surge valve in an open state according to the present invention.

FIG. 3 is a cross-sectional view of an exemplary diaphragm according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

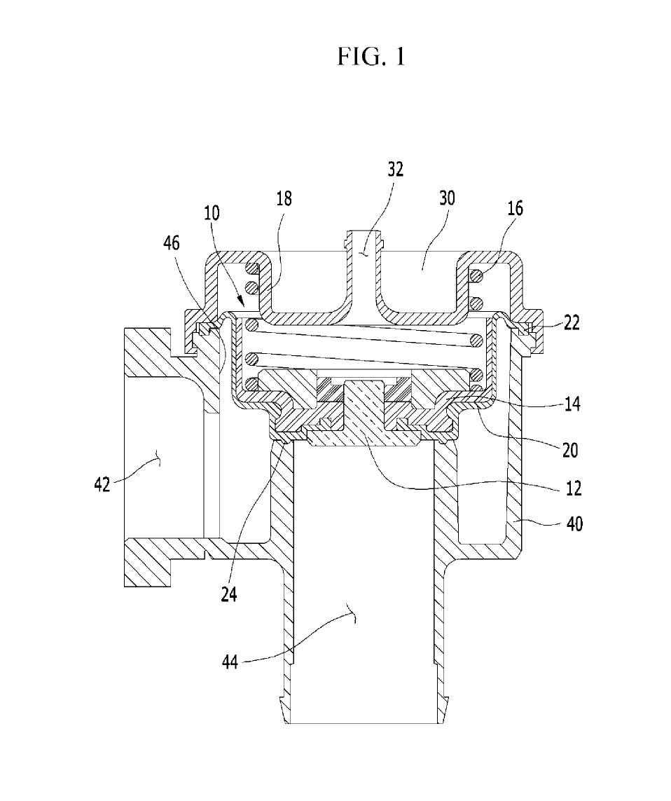

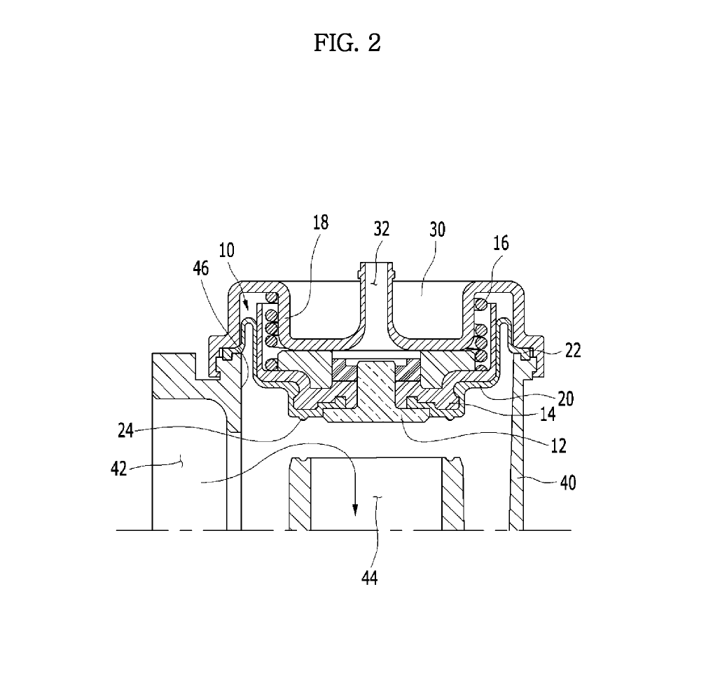

FIG. 1 is a configuration diagram illustrating an anti-surge valve according to various embodiments of the present invention in a closed state. FIG. 2 is a diagram illustrating an anti-surge valve according to various embodiments of the present invention in an open state.

Referring to FIGS. 1 and 2, the anti-surge valve 10 is mounted in a housing 40. The housing 40 includes an air entrance 42, an air exit 44, and an opening 46.

The air entrance 42 is a path formed in the housing 40 to be connected to a rear air path of a compressor provided in a turbocharger. That is, the air entrance 42 connects the inside of the housing 40 to the rear air path of the compressor.

The air exit 44 is a path formed in the housing 40 to be connected to a front air path of the compressor provided in the turbocharger. That is, the air exit 44 connects the inside of the housing 40 to the front air path of the compressor.

The opening 46 is opened in such a manner that the anti-surge valve 10 is inserted into the housing 40. The opening 46 is coupled to a valve cap 30. Furthermore, the valve cap 30 is provided to cover the opening 46 after the anti-surge valve 10 is disposed in the housing 40. Furthermore, as the valve cap 30 is coupled to the housing 40, the anti-surge valve 10 is mounted in the housing 40.

The valve cap 30 includes a negative pressure path 32 and a spring mounting portion 18. The negative pressure path 32 is formed in the valve cap 30 to be connected to an intake path at an intake manifold. That is, the negative pressure path 32 connects the intake path to the inside of the housing 40.

The anti-surge valve 10 includes a piston 12, an operating unit 14, a spring or biasing means 16, and a diaphragm or the like 20.

The piston 12 is provided to reciprocate inside the housing. Furthermore, the piston 12 is provided to push the operating unit 14 in one direction or the opposite direction thereof. That is, the operating unit 14 is moved together with the piston 12.

The spring or biasing means 16 is provided to push the operating unit 14 in one direction, using an elastic force. Furthermore, the spring 16 is mounted on the spring mounting portion 18. That is, the spring 16 is interposed between the valve cap 30 and the operating unit 14.

Meanwhile, the operating unit 14 is disposed to partition the inside of the housing 140 into two spaces. Furthermore, the two spaces include a space between the valve cap 30 and the operating unit 14 and the opposite space based on the operating unit 14.

When the operating unit 14 is moved in a direction where the spring 16 pushes the operating unit 14, the operating unit 14 closes the path such that the air entrance 42 and the air exit 44 do not communicate with each other as illustrated in FIG. 1.

Furthermore, when a negative pressure is generated in the intake path at the intake manifold, a negative pressure is generated in the space between the operating unit 14 and the valve cap 30 communicating with the intake path by the negative pressure path 32, and the piston 12 and the operating unit 14 are moved in a direction approaching the valve cap 30. Therefore, the path is opened to connect the air entrance 42 to the air exist 44 as illustrated in FIG. 2.

When the path is opened to connect the air entrance 42 and the air exit 44, high-pressure air flowing through the rear air path of the compressor is recirculated to the front air path of the compressor after sequentially passing through the air entrance 42, the inside of the housing 40 and the air exit 44.

The diaphragm 20 is disposed to cover the outer surface of the operating unit 14 in the opposite space of the valve cap 30 based on the operating unit 14. Furthermore, the diaphragm 20 is formed in a shape corresponding to the shape of the operating unit 14. Furthermore, the diaphragm 20 includes a coupling portion 22 coupled to the valve cap 30 and the housing 40.

As the coupling portion 22 of the diaphragm 20 is inserted between the housing 40 and the valve cap 30, the diaphragm 20 is coupled to the valve cap 30 and the housing 40. Furthermore, the inside of the housing 40 is partitioned into the two spaces by the diaphragm 20.

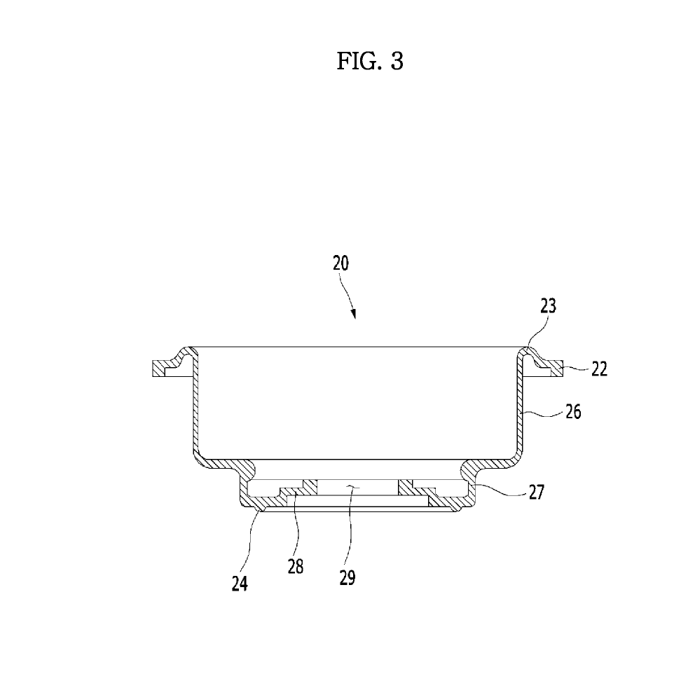

FIG. 3 is a cross-sectional view of the diaphragm according to various embodiments of the present invention. The diaphragm 20 is formed in a substantially cylindrical shape of which the top surface is opened and the bottom surface is partially opened. That is, the diaphragm 20 may be formed in a substantially hollow cylindrical shape. Furthermore, the diaphragm 20 includes a circumference portion 23, the coupling portion 22, a side portion 26, a stepped portion 27, an opening and closing portion 24, a piston receiving portion 28, and a piston insertion hole 29.

The circumference portion 23 is formed along the circumference of the opened top surface. Furthermore, the cross-section of the circumference portion 23 is formed in a substantially upside-down U-shape.

The coupling portion 22 is extended from the circumference portion 23 to the outside. Furthermore, the coupling portion 22 is formed along the circumferential direction at an outer end of the circumference portion 23. Furthermore, the coupling portion 22 is formed at a lower level than the circumference portion 23.

The side portion 26 corresponds to the side surface of the cylinder extended substantially vertically from an inner end of the circumference portion 23. Furthermore, the side portion 26 has substantially uniform inner and outer diameters along the longitudinal direction of the cylinder. The longitudinal direction of the cylinder corresponds to the vertical direction of FIG. 3.

One end of the side portion 26 extended substantially vertically from the circumference portion 23 is extended by a predetermined length, and bent toward the center of the cylinder.

The stepped portion 27 is extended substantially vertically from the one end of the side portion 26 which is bent toward the center. That is, the stepped portion 27 corresponds to a side surface of the cylinder having a smaller diameter than the side portion 26. Therefore, the side surface of the cylinder is formed to be stepped one time.

The stepped portion 27 extended vertically from the one end of the side portion 26 is connected to the bottom surface of the cylinder.

The opening and closing portion 24 is formed on the bottom surface of the cylinder. Furthermore, the opening and closing portion 24 is protruded from the bottom surface of the cylinder. Furthermore, the protruded opening and closing portion 24 is formed along the circumferential direction. That is, the protruded opening and closing portion 24 is formed in a substantially circular shape.

The piston receiving portion 28 and the piston insertion hole 29 are formed in the opening and closing portion 24 formed in a substantially circular shape.

The piston receiving portion 28 is formed in such a manner that the piston 12 is received on the bottom surface of the diaphragm 20. Furthermore, the piston receiving portion 28 is inserted between the piston 12 and the operating unit 14. Furthermore, the piston receiving portion 28 may be formed to be stepped upward depending on the shape of the piston 12.

The piston insertion hole 29 is formed in a substantially circular shape at the center of the bottom surface of the diaphragm 20 such that the piston 12 is inserted into the piston insertion hole 29.

The diaphragm 20 may be formed of plastic resin or rubber. Furthermore, the diaphragm 20 according to the present invention may be formed of a fluoroelastomer such as FKM60 or other suitable materials. When the diaphragm 20 is formed of FKM60, the hardness, tensile strength, and elongation of the diaphragm 20 may be improved in comparison with conventional materials.

According to the present invention, the shape of the diaphragm 20 is improved, and the diaphragm 20 is formed of a material having an improved durability, thereby improving the reliability of the anti-surge valve 10. Therefore, the function of the engine may be prevented from being deteriorated.

For convenience in explanation and accurate definition in the appended claims, the terms “top” or “bottom”, “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents. appended claims.

What is claimed is:

1. An anti-surge valve that opens or closes a path depending on a negative pressure formed at an intake manifold, the anti-surge valve comprising:
an operating unit movable in a direction in response to the negative pressure formed at the intake manifold;
a spring means provided to push the operating unit in a direction opposite to the moving direction of the operating unit in response to the negative pressure formed at the intake manifold;
a spring mounting portion for mounting the spring means; and
a diaphragm disposed to cover an outer surface of the operating unit, wherein the diaphragm is formed in a substantially hollow cylindrical shape and comprises:
a circumference portion formed along a circumference of an opened top surface of the diaphragm,
a coupling portion formed along a circumferential direction from an outer end of the circumference portion, and
a side portion extended substantially vertically from an inner end of the circumference portion, and has substantially uniform outer and inner diameters.

2. The anti-surge valve of claim 1, wherein the diaphragm further comprises a stepped portion formed to be stepped from the side portion and having a smaller diameter than the side portion, wherein
a bottom surface of the diagram is connected to the stepped portion,
one end of the side portion is bent toward the center of the cylinder, and
the stepped portion is extended substantially vertically from the bent end of the side portion to the bottom surface of the diaphragm.

3. The anti-surge valve of claim of claim 2, wherein the circumference portion has a cross-section formed in a substantially upside-down U-shape.

4. The anti-surge valve of claim of claim 2, wherein the coupling portion is formed at a lower level than the circumference portion.

5. The anti-surge valve of claim of claim 1, wherein the diaphragm is formed of a material comprising FKM60.
